(19) United States
(12) Patent Application Publication
(10) Pub. No.: US 2020/0261290 A1
(43) Pub. Date: Aug. 20, 2020

(54) ADJUSTABLE SURFACE APPARATUS

(71) Applicants: David Ross, Kissimmee, FL (US); Rositsa Stoykova, Kissimmee, FL (US)

(72) Inventors: David Ross, Kissimmee, FL (US); Rositsa Stoykova, Kissimmee, FL (US)

(21) Appl. No.: 15/947,099

(22) Filed: Apr. 6, 2018

(51) Int. Cl. A61G 7/015; A61G 7/018

(52) U.S. Cl. CPC A61G 7/015; A61G 7/018

(57) ABSTRACT

Embodiments are described for a articulating bed frame which may be utilized as a bed, a chair, or a lift chair. The articulating bed frame has a support frame with a mattress resting thereon. A plurality of support members is in operative communication with at least one motor. A controller allows the user to select from a plurality of configurations and thus modulate the orientation of the bed.

### FIELD

The embodiments presented relate to an articulated bed frame having the ability to effectively move a foundation and a mattress thereon to a variety of configurations and orientations.

### BACKGROUND

Adjustable beds have been utilized for many years to modify the contours of the top surfaces on a mattress. In this manner, the user may elect a desired contour either manually, or via a remote and effectively support different portions of the bodies of persons lying on the mattress. Their use in private homes as increased in recent years due to the popularity of television and video viewing as well as the age of the population.

While adjustables beds may be used in the home to cater towards individual comfort needs, they are commonly used in hospitals or convalescent homes by patents who must spend long periods of time recovering. This allows care providers to modify the resting position of the patient to promote healing, overall health, and comfort.

The conventional adjustable bed may comprise a mattress resting upon an articulated support member. The support member may be in communication with a motor or manual mechanism permitting the movement of various components of the bed.

While adjustable beds are available in the current art, no such design exists that functions as a bed, a chair, as well as a lift chair to assist users with compromised movement due to a multitude of conditions. It can be seen that an advancement in the arts is warranted, one such advance is described in the embodiments presented herein.

### SUMMARY OF THE INVENTION

Embodiments described herein provide for an articulating bed frame apparatus having a bed frame and mattress thereon. A pla plurality of motors are operatively connected to the mattress via at least one actuator which moves the mattress into a plurality of orientations.

In an aspect of the present invention, the mattress has a top portion, a middle portion, and a lower portion, such that the top portion supports a user's upper body, and the lower portion supports the user's lower legs. A first motor is operatively connected to the top portion, while a second motor is operatively connected to the lower portion. A fourth motor is operatively connected to the middle portion.

In another aspect, a foothold extends distally from the lower portion having a third motor and a third actuator operatively connected thereto. The bed frame may also have a support surface contacting the mattress.

In an aspect, the user may select a first orientation wherein the top portion, the middle portion, and the lower portion of the mattress is on a horizontal plane. The user may also select a second orientation wherein the top portion and the lower portion are on a substantially parallel plane, and wherein the middle portion is on a horizontal plane. A third orientation may be selected, wherein the apparatus is oriented as a lift chair while in a fourth orientation, the top portion is raised, and the middle portion and lower portion are on a horizontal plane. In a fifth orientation, wherein the top portion is raised, the middle portion is raised to oppose the top portion, and the lower portion is on a horizontal plane.

In another embodiment, an articulating bed frame system has a bed frame comprising a support surface dimensioned to support a mattress thereron. A plurality of motors are operatively connected to the mattress via a plurality of support members, with each support member is comprised of at least one linear actuator. At least one auxiliary support member is configured to support the mattress while a controller is in communication with a processor, which affects each of the plurality of motors individually. The processor is configured to perform a plurality of steps including; selecting an orientation via the controller, receiving an orientation input from the controller, affecting at least one of the plurality of motors, and retaining the mattress in the selected orientation.

In an aspect, the apparatus may be comprised of a headboard and a plurality of legs. Each leg may be in communication with an actuator to raise and lower the bed frame as desired.

Further features and advantages of the invention will appear more clearly on a reading of the following detail description of the preferred embodiment of the invention, which is given by way of non-limiting example only and with reference to the accompanying drawings.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates the adjustable bed in a flat orientation, according to an embodiment of the present invention;

FIG. 2 illustrates the adjustable bed in a contoured orientation, according to an embodiment of the present invention;

FIG. 3 illustrates the adjustable bed in further contoured orientation, according to an embodiment of the present invention;

FIG. 4 illustrates the adjustable bed in a lift chair orientation, according to an embodiment of the present invention;

FIG. 5 illustrates the adjustable bed in a contoured orientation, according to an embodiment of the present invention;

FIG. 6 illustrates the adjustable bed in a contoured orientation, according to an embodiment of the present invention;

FIG. 7 illustrates the adjustable bed in a contoured orientation, according to an embodiment of the present invention; and

FIG. 8 illustrates the adjustable bed in a contoured orientation, according to an embodiment of the present invention.

### DETAILED DESCRIPTION

The specific details of the single embodiment or variety of embodiments described herein are set forth in this application. Any specific details of the embodiments are used for demonstration purposes only and no unnecessary limitation or inferences are to be understood therefrom.

Any reference to “invention” within this document is a reference to an embodiment of a family of inventions, with no single embodiment including features that are necessarily included in all embodiments, unless otherwise stated. Furthermore, although there may be references to “advantage's” provided by some embodiments, other embodiments may not include those same advantages, or may include different advantages. Any advantages described herein are not to be construed as limiting to any of the claims.

Before describing in detail exemplary embodiments, it is noted that the embodiments reside primarily in combinations of components related to the system. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Specific quantities, dimensions, spatial characteristics, compositional characteristics and performance characteristics may be used explicitly or implicitly herein, but such specific quantities are presented as examples only and are approximate values unless otherwise indicated. Discussions and depictions pertaining to these, if present, are presented as examples only and do not limit the applicability of other characteristics, unless otherwise indicated.

In general, the invention described herein relates to an articulating bed apparatus 100 permitting a user to get into and out of bed far easier than a conventional non-articulating design. This not only benefits the patient (e.g. the user) but also the caregiver who may have difficulty moving the patient. The construction results in ease of transfer between the bed, and a wheelchair or scooter such that the patient is minimally strained.

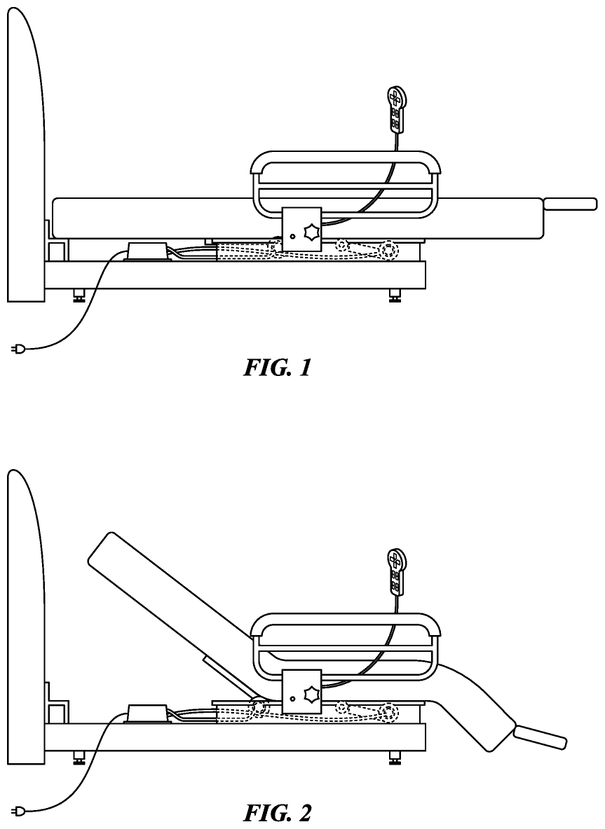

In reference to FIG. 1 an embodiment of the articulating bed apparatus 100 is illustrated wherein the bed 100 is in a flat orientation such that the mattress surface 102 lies in a single substantially horizontal plane. The mattress surface 102 contacts the user during use while the mattress 104 body extends between a plurality of support members 106 comprising a support frame 108 which provide moveable support to the mattress 104. The support frame 108 is constructed to allow the articulating bed 100 to rest firmly on the ground during use and while the bed is articulating and in motion. A motorized assembly individually affects each of the support members to result in the controlled movement of the apparatus 100.

The mattress is comprised of a top portion 110 whereon the head and upper body of the user is typically supported. A middle portion 112 supports the seat of the user including the hips and upper legs while a lower portion 114 supports the legs of the user. A foothold 116 extending distally from the lower portion may be utilized to support the feet of the user.

In an embodiment, the apparatus 100 derives energy from power source 118 which is typically connected with a wall outlet. One skilled in the arts may appreciate that alternator power sources may be utilized depending on the specific application and setting of the apparatus 100.

A controller 120 is in communication with a processor 122 and motor 124 to articulate the apparatus as shown in FIGS. 1-6 as well as provide additional features inherent with the apparatus 100. In an embodiment, the controller 120 may include functions for ON/OFF, as well as each configuration or combination of configurations and orientations provided herein. Further, the controller may have a list of predetermined configurations that permit the user to select a configuration and have the processor 122 affect the motor 124 to move the apparatus 100 into the correct selected position.

The motor assembly 124 is in communication with a plurality of linear actuators configured to affect the support members. In one embodiment, a first motor may be utilized to raise and lower an actuator in communication with the top portion 110 of the mattress 104 to raise and lower the top portion 110. Meanwhile a second motor is in communication with the lower portion 114 of the mattress 104 to raise and lower the lower portion 114. A third motor may be utilized to raise and lower the foothold 116. To utilize the apparatus 100 as a lift chair (see FIG. 4), a fourth motor may be utilized to affect an actuator acting on the middle portion 112 to raise and lower the middle portion 112 in reference to the support frame 108.

In an embodiment, the apparatus 100 is comprised of a headboard 126 extending perpendicular in reference to the support frame 108. Legs 128 may be utilized to contact the ground, in an embodiment wherein the legs 128 are positioned between the ground and the support frame 108. Persons skilled in the arts may appreciate that a large variety of headboard configurations, leg configurations, and support frame configurations may be implemented without deterring from the spirit of the present invention. Headboard, legs, and support frames may be stationary, or in communication with an actuator affecting their movement. In an example, each leg 128 may be in communication with an actuator permitting the user or care provider to raise and lower the entire support frame 108 or raise a single side to elevate the head or feet of the patient such as those with gastric reflux who commonly sleep with their heads slightly raised.

In yet another embodiment, auxiliary support members 130 may be utilized to provide further structural support to the mattress 104.

Referring now to FIG. 2, the apparatus 100 is illustrated in a semi-upright orientation. In the present embodiment, a first motor has affected first actuator 206 and support member 106 to raise the top portion 110 of the mattress 104. An angle between 0° and 60° between the mattress bottom 202 and support surface 204 is reached. Similarly, a second actuator and second motor affect the lower portion 114 to raise and lower between a flat orientation (see FIG. 1) and lowered orientation (see FIG. 2).

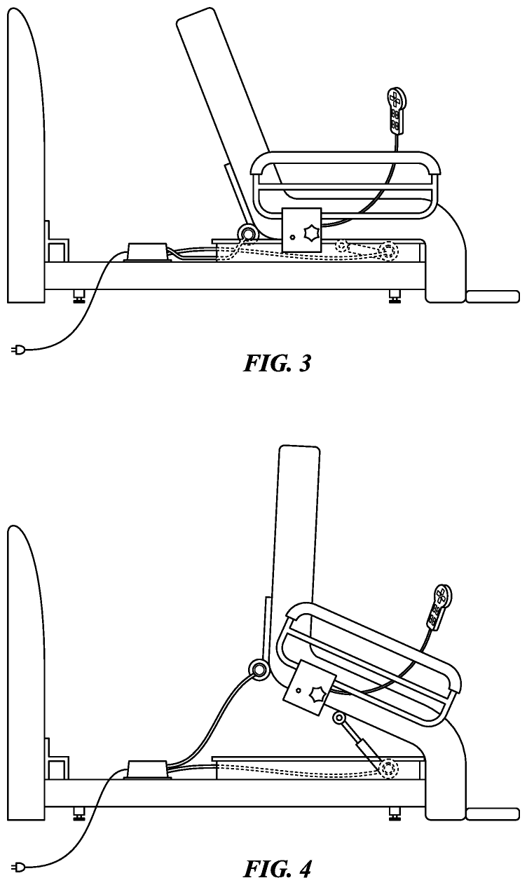

In reference to FIG. 3, the apparatus 100 is further illustrated in an upright orientation wherein the first motor has affected the first actuator 206 and support member 106 such that an angle between 60° and 90° is achieved between the mattress bottom 202 and support surface 204.

FIG. 4 illustrates a lift chair orientation wherein a fourth actuator 402 and fourth motor 404 raise the middle portion 112 vertically from the support surface 204 facilitating the standing and sitting of the user. In the lift chair orientation, the user may easily enter and exit a wheelchair, scooter, or similar assisting device as well as stand while having a support at their back. This may help user and patients with walking and other movement related disabilities, while taking strain off of caretakers who would otherwise need to manually lift the patient.

Meanwhile, the foothold 116 may articular utilizing a third motor and third actuator to raise and lower as seen in contrast in FIGS. 1-3.

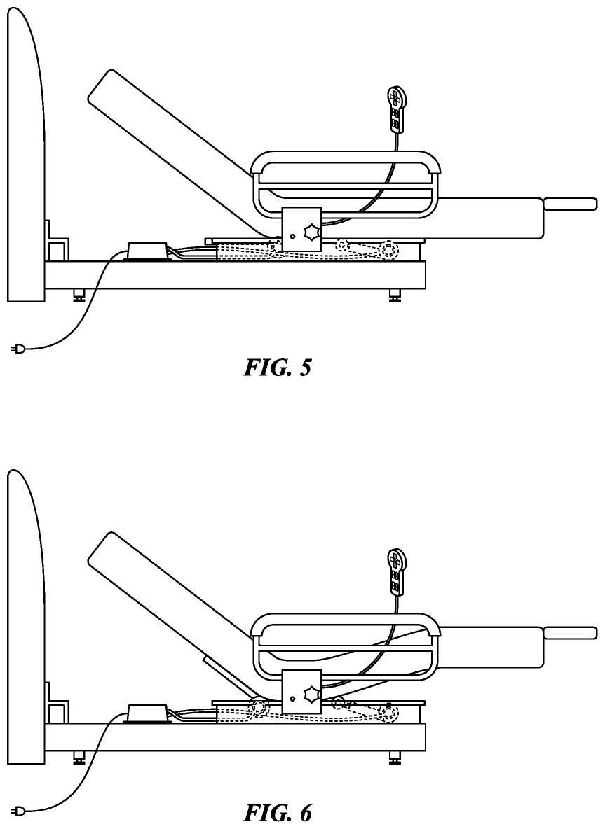

In reference to FIG. 5, the lower portion 114 and foothold 116 are in a horizontal plane while in FIG. 6 the middle 112 portion is raised.

In at least one embodiment, each motor is operatively connected to the support members 106 such that when operated it moves the support members and provides a plurality of orientations for the mattress 104.

The motor driven support members 106 are configured to lie flat on or within the support surface 204 of the apparatus 100 when in a flat configuration such as that shown in FIG. 1. In the manner, the bed lies flat on the surface without any poking or prodding by the motor driven members. The basic lower frame may include four leg posts, casters fitted on each of the legs, and a plurality of members comprising the frame 108.

The first and second motors can be operated by a pendant-type or wireless controller placed on a night stand adjacent to the head end of the bed. The user has easy access to the controller due to the combined pivotal and transverse movements of the head section of the bed. The multiconductor electrical pendant cord may have a small diameter especially if low voltages are used to activate switching of high voltages in a controller located under the bed. Infra-red or radio frequency types of controllers may be used when it is desired to eliminate the direct wiring and/or when the controller is to perform other functions such as switching the lights or operating television, radio or video cassette recorders. A massage motor can also be incorporated into this bed as would be apparent to those skilled in the art.

Advantageously, the person lying on the bed experiences a similar movement; that is, his shoulders move in a straight vertical line. Thus, his head does not move horizontally out of position relative to the lamps, radios, telephones or other nearby objects as the head portion of the mattress is moved between its flat and raised positions. Also, his buttocks are not pinched by the crease in the mattress as it folds up. The foundation body member has articulated foot, thigh and seat portions which are adjustable by another electrical motor to configure the upper surface of the body portion of the mattress as desired.

As described, each motor driven member moves with respect to the frame 108 which lies stationary to provide a fully supported structure to the user. The apparatus 100 is dimensioned to minimize the risk of toppling, bending, or a failure to support the user in a plurality of configurations.

Each support member pivots about a hinge 402 linking the frame 108 thereto. Each apparatus may include a side rail assembly 404 on each side of the frame 108 to facilitate the movement of the user on the bed. In this manner, the user may place their hands on each side rail assembly 404 and thrust upwards to aid the action of standing.

The apparatus 100 may be in communication with a processor 602 which receives a signal from the controller 120. In turn, the processor affects each actuator according to reach the plurality of orientations as illustrated in FIGS. 1-6.

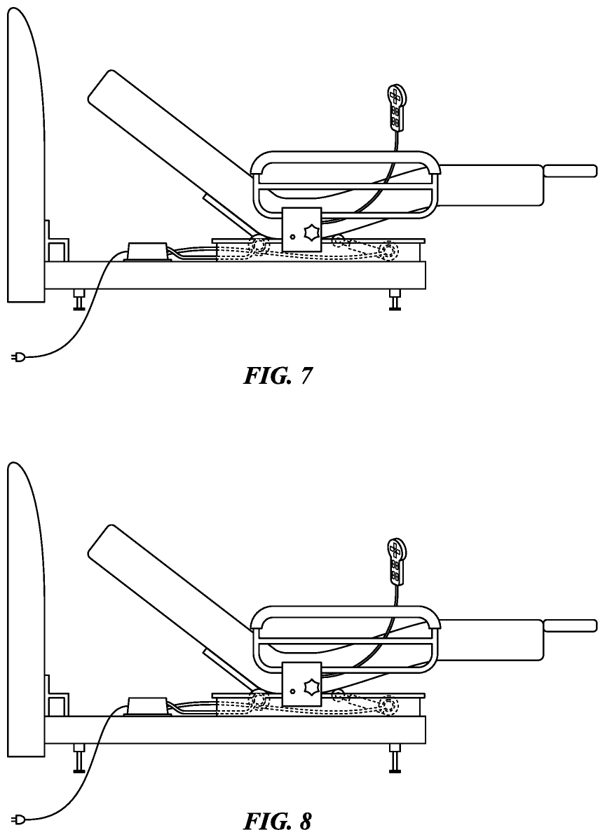

In reference to FIG. 7, each leg 128 has been partially extended to raise the entire support frame 108 while in FIG. 8, each leg 128 has been further extended to raise the entire support frame 108 further off the ground. Although the user may raise each leg 128 evenly, it is contemplated that each leg may be adjusted independently to selectively raise the support frame 108 at a desired angle.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. An articulating bed frame apparatus comprising:
a. a bed frame;
b. a mattress atop of the bed frame; and
c. a plurality of motors operatively connected to the mattress via at least one actuator.
wherein each each actuator moves the mattress into a plurality of orientations.

2. The apparatus of claim 1, wherein the mattress is comprised of a top portion, a middle portion, and a lower portion, wherein the top portion supports a users upper body, and wherein the lower portion supports the users lower legs.

3. The apparatus of claim 2, wherein a first motor is operatively connected to the top portion, wherein a second motor is operatively connected to the lower portion, and wherein a fourth motor is operatively connected to the middle portion.

4. The apparatus of claim 2, further comprising a foothold extending distally from the lower portion.

5. The apparatus of claim 4, wherein a third motor is operatively connected to the foothold.

6. The apparatus of claim 1, wherein the bed frame further comprises a support surface contacting the mattress.

7. The apparatus of claim 1, wherein the apparatus is communicatively connected to a power source.

8. The apparatus of claim 2, having a first orientation wherein the top portion, the middle portion, and the lower portion of the mattress is on a horizontal plane.

9. The assembly of claim 2, having a second orientation wherein the top portion and the lower portion are on a substantially parallel plane, and wherein the middle portion is on a horizontal plane.

10. The assembly of claim 1, having a third configuration, wherein the apparatus is oriented as a lift chair.

11. The assembly of claim 2, having a fourth configuration, wherein the top portion is raised and the middle portion and lower portion are on a horizontal plane.

12. The assembly of claim 2, having a fifth configuration, wherein the top portion is raised, the middle portion is raised to oppose the top portion, and the lower portion is on a horizontal plane.

13. An articulating bed frame system:
a. a bed frame comprising a support surface dimensioned to support a mattress thereron;
b. a plurality of motors operatively connected to the mattress via a plurality of support members, wherein each support member is comprised of at least one linear actuator;
c. at least one auxiliary support member configured to support the mattress;
d. a controller in communication with a processor, wherein the processor affects each of the plurality of motors individually, wherein the processor is configured to perform the following:
i. selecting an orientation via the controller;
ii. receiving an orientation input from the controller;
iii. affecting at least one of the plurality of motors; and
iv. retaining the mattress in the selected orientation.

14. The system of claim 13, further comprising a headboard, wherein the headboard extends substantially vertical.

15. The system of claim 13, further comprising a plurality of legs extending between a ground surface and the bed frame.

16. The system of claim 15, wherein each of the plurality of legs are an actuator operatively connected to at least one motor.

17. The system of claim 13, wherein the system is communicatively connected to a power source.

18. The system of claim 13, wherein each orientation has a unique configuration between the top portion, middle portion, lower portion, and foothold.

19. The system of claim 13, wherein the bed frame is a chair.

20. The system of claim 13, wherein the bed frame is a lift chair.
